(19) United States
(12) Patent Application Publication
(10) Pub. No.: US 2019/0295125 A1
(43) Pub. Date: Sep. 26, 2019

(54) Artificial intelligence autonomous building system

(71) Applicants: Fabio Alessio Marino, San Marcos, CA (US); Paolo Menegoli, San Jose, CA (US)

(72) Inventors: Fabio Alessio Marino, San Marcos, CA (US); Paolo Menegoli, San Jose, CA (US)

(73) Assignee: Awenyx Inc., San Jose, CA (US)

(21) Appl. No.: 16/356,270

(22) Filed: Mar. 18, 2019

Related U.S. Application Data
(60) Provisional application No. 62/648,270, filed on Mar. 26, 2018.
(60) Provisional application No. 62/687,716, filed on Jun. 20, 2018.

(51) Int. Cl. G06Q 30/02; G05B 15/02; G06Q 30/06; G06N 20/00; G06K 9/62

(52) U.S. Cl. CPC G06Q 30/0255; G05B 15/02; G06K 9/6267; G06N 20/00; G06Q 30/0641

(57) ABSTRACT

The present invention describes an autonomous building system capable of operating based on processing and analysis of collected data by means of Artificial Intelligence algorithms. The data can be gathered from within the system and/or from external networks. The autonomous building system will assist its users in every tasks from enhanced security to energy savings, from health monitoring and data collection to education, from financial assistance to social activities. In particular the described autonomous building is capable of making autonomous decisions and online purchases getting funds out of a dedicated financial account. The autonomous building may become the target of contextual advertising to promote products and/or services.

### FIELD OF INVENTION

The present invention is in the field of home automation and smart home systems. The present invention is further in the field of artificial-intelligence based systems. Particularly, it relates to a fully integrated artificial intelligence home automation systems with multi-users capability. The implementation is not limited to a specific technology, and applies either to the invention as an individual component or to inclusion of the present invention within larger systems.

### BACKGROUND

Technology is the key to enhance human evolution and reach incredible milestones for the human kind. In particular, the immense amount of data that are becoming available today are the basis of a new industrial revolution, where Artificial Intelligence (AI) based algorithms are used to identify optimum patterns so as to solve some of the most challenging problems.

Data mining (collecting, processing, storing and analyzing data in order to discover (and extract) new information from it) can be used for very sector specific applications, such as: finance and banking, to create accurate risk models for loans and mortgages; marketing, to improve online conversion rates, increase customer satisfaction and create targeted advertising campaigns; retail stores, to optimize the layout of their stores in order to improve customer experience and increase profits; tax governing bodies to detect fraudulent transactions and single out suspicious tax returns or other business documents; or manufacturing, to improve product safety, usability and comfort.

However, data mining and AI algorithms can be also used to achieve far greater results, such as autonomous driving vehicles to decrease car accidents and improve transport efficiency, or in medical applications to create better user specific diagnosis. AI based data mining can be therefore used to completely revolutionize human society and to create extremely advanced technologies to help us live better, longer and safer lives.

The key to allow these incredible advances in technology is the access to information and in particular to a complete set of user specific data that can be combined so as to understand and identify possible patterns.

So far, data acquisition has been limited to human discrete actions through e.g. internet and credit cards use, missing comprehensive and continuous real inside data. This is due to the limitation of data access. For example, online retail stores (as e.g. Amazon) have access to shopping habits of its users, banks have access to the financial habits, entertainment companies (as e.g. Netflix) have access to user entertainment preferences, grocery stores have access to user food habits, and so on. However, none of these have access to each other data or to what the user is doing between the separate interactions, leaving the user profile greatly incomplete. Which in turn greatly limits their capability to use AI data mining to improve the user life. In order to gain full access to a meaningful and comprehensive set of data that can be utilized to improve human life from a multi-front, we therefore need to rethink the data acquisition methods that have been used so far.

### BRIEF SUMMARY OF THE INVENTION

The present invention describes a fully integrated AI based home automation system with multi-users capability aimed to revolutionize the current concept of data acquisition, data management and data processing, allowing access to user data never available before (such as constant bio-signal monitoring) and enabling a new data management structure, where all user related data can be elaborated as a whole, including shopping preferences, dietary habits, financial habits, exercise activities, biological activities, power/resources consumption and so on.

To achieve the objectives described above, the disclosed home system may comprise one or more of the following characteristics:

### Human-Inspired Characteristics:

1. Brain-like control: the home system peripheries are all connected to a main unit or mainframe which can supervise all of them in real-time and analyze their data as a whole. This mainframe can be placed locally so as to increase privacy or it can be a server or a computational unit connected through the internet (preferably with encryption). Aside from the most basic and common (wired and wireless) communication protocols such as Bluetooth and Wi-Fi, the new system may leverage the standard power line present in any house to transmit and receive video, audio, internet data and any other communication/control/feedback or monitoring signal between the mainframe (or hub) and all (or a portion of) the peripherals. Any electrical plug and bulb socket becomes therefore an access point, greatly improving the system reliability, efficiency, performance and privacy. A block-chain or user permission based technology may be used to make sure that a unit has the user approval to make critical decisions.
2. Completeness: Humans are capable to perform different types of actions related to different aspect of their life. Similarly, the home system has to be able to help its user on a wide range of aspects. The system therefore, should be a multi technology platform including not only predictive systems and actionable features, but also robotic automation, homecare, safety, resource and energy managements and generation systems, and/or disability oriented features.
3. User specific structure: Every person is different and interacts differently with his/her surroundings. Therefore, the home system provides each user with its own specific profile so as minimize the required user interaction as much as possible. Each profile is created the first time the user logs into the system and/or enters the house. This profile may have one or more of the following characteristics: it contains all the habits patterns of the user; it contains personal information of the user; it is continuously updated based on one or multiple learning algorithms; it is transferable from house-to-house in case the user moves; it continuously uploads information from all user accounts (Facebook, and/or yelp, and/or amazon, and/or bank accounts, etc) and/or user's phone (e.g. GPS data); it contains medical information and records (it becomes the main medical record keeping of a person); it can be used within a larger AI based management system to identify the person also in other houses/offices/stores having the same or similar system herein disclosed; it is therefore the most complete and reliable collection of user information. Under user authorization it can be partially accessed by other persons or institutions, such as the user's doctor; it allows the automated home system to give suggestions and information to the user related to its interests and personal situation.
4. Full awareness: The home system performs actions based on the analysis of as many variable as possible so as to be fully aware of what is actually happening inside the house and in its surrounding. To do so, the home system needs to combine all the historical and real-time data obtainable from not only the interaction and monitoring of each user (internal personal data) and/or from different user accounts, such as Amazon, Facebook, bank accounts and so on (external personal data), but also from the interactions between multiple users and their interaction with all the sensors and/or TOT and/or appliances of/in the house as a whole (internal cross-dependencies data), in an attempt to identify all possible cross-dependencies between events, including temporal relationships. Furthermore, data from external sources (external cross-dependencies data), including internet, and news can be used to increase the completeness of the information set.
5. Self awareness: Each house system may have its own profile which may be continuously updated as the ones of its users. This profile, e.g. in combination with a dedicated neural network, can be used to create the house own “personality”.
6. Self-learning based approach: As the users evolve, so has to do the house. The home system needs to be able to learn and dynamically update the profile of each user and its own to adapt to the new user habits and to the knowledge that it continuously collects through all its interfaces and monitoring systems. An artificial intelligence based program is used to allow said home system to learn and predict user specific habits and needs. This allows a continuously changing habit profile for each user, which evolves based on user specific needs and new habits. Similarly, the house “personality” evolves alongside with its users. The developed home system can effectively behave as a human assistant replicating/substituting human intervention. The self-learning core program of the home system may be composed from one or multiple modules implementing different AI algorithms optimized for different functions, to mimic the human brain. A dedicated module can be used to create the home personality. Furthermore, these modules may have hidden nodes in common to each other so as to comprehensively analyze the whole environment. Each one of these modules can comprise one or multiple algorithms running in parallel or in series and based on the same data. In order to speed up the learning process, the system may use: collaborative filtering algorithms, which employ user rating and/or choices from other users and houses, to characterize features and actions that are implemented in the house (similar to what machine learning programs do for classifying movies and learn user preferences); transfer learning approaches and/or vocabulary based database structures, by collecting a general database that can be reused for all users, like a vocabulary of cross-dependences between different users and/or different electronic features in the house. For example user j tells to the main frame that he likes to turn on the lights before he opens the garage in the morning. Then the same proposal is made to user i in another and/or same house. Crowdsourcing and surveys can also be used to form the starting database. Extra neurons can also be automatically added (or deleted) based on learning speed and data volume. Furthermore, the described program can ask questions and analyze answers.
7. Smart interaction: Once introduced to each other, people are able to interact between them without requiring identification tags. Similarly, the home system can monitor all the input features without requiring explicit user physical interaction or requiring the user to wear identification tags or wearable monitoring devices. Hidden smart scales, face/id recognitions, sensors, camera, LIDAR, Wi-Fi mapping techniques, etc. . . . are used instead to gather user information. IR imaging systems may be used to record images in three dimensions and have a better face/id recognition (3D face recognition). Alternatively, or in conjunction, rotating sensors (or cameras), LIDAR or thermal imaging systems can be used to identify and track each user. Many other solutions are possible.

### Beyond Human Characteristics:

8. Connectivity: As of today, thanks to the internet and multi-media communication systems, human beings are connected to each other and are able to communicate also at large distances. The herein disclosed house system needs therefore to be able to leverage also external information coming from other smart homes systems and from media to improve safety, homecare, and user efficiency. It is possible to build the system so that anywhere the users goes, home, offices shops and so on, everything is connected to the described system, so that access to information is correctly organized, the data acquisition process is maximized, and, with it, the capability to improve the users' lives.
9. Customization: the house system and the features thereof can be customized based on the targeted user, based on age, or education or personal preferences. For instance a smart home for seniors may have some needs that other occupants may not care about, and therefore the features offered in the house can be tailored to reflect that.
10. Different access types: Different types of access to peripherals can be made available including supervised (e.g. for kids), unsupervised (e.g. for adults), and temporary (for guests).
11. Accessibility: The user has control access from his phone (with or without voice commands) and/or from the wall unit and/or through voice and/or gesture. Control can be complete or limited, based on user privacy profile. The user ability to communicate with the house system through his smart phone or other suitable personal communication device, allows the house system to become the general personal assistant of the user also outside the premises.

### System Design Characteristics:

12. Reliability: the most important and/or challenging peripherals may be hard wired to avoid incompatibility and/or prevent privacy and/or energy supply concerns.
13. Privacy: no data is shared outside the house network except for what is allowed by the main-frame under user permission. Furthermore, data-elaboration may be done locally to maximize privacy. Encryption systems can be used to increase privacy. Data access may be allowed only through biometrics keys, such as fingerprints (or other identification systems, such as IR based 3D face recognition). Video systems with imaging system different from the human one may be used (at least in the most sensitive house areas such as bathrooms and bedrooms) to prevent privacy concerns. For example, only the position and id number of each user could be monitored and recorded, not his or her actual image. Instead of conventional video cameras, IR sensors and thermal imaging systems (and/or rotating sensors and/or camera or LIDAR systems) may be used in the most sensitive spaces of the house. Only contours of people bodies or stylized figures or cuboids/parallelepipeds may be recorded. Other examples include the use of hard encoding/encryption, e.g. a special camera can be used, where the video pixels connection order has been changed with respect to conventional cameras, so as to create an hard encoding/encryption in the video signal which can be decoded/decrypted only by knowing the special pixels order. Many other encryption techniques, such as software based encryption, can also used to memorize the images. Other possibilities include the use of opaque (in the visible range) films placed in front of the camera sensors to record only IR images so as to increase privacy.
14. Contextualized advertisements: Very pertinent and useful advertisement messages and media can be shown to the user, since the house system knows the user physical location inside the house, what he is doing, and at when, so as to avoid useless information flow to the users. In addition the advertisements may be specifically targeting the users based on past history, on profiles, or in general on any data and preferences analyzed and accumulated by the house system through time.
15. Machine-to-Machine advertisements: The disclosed home system may make decisions regarding what to purchase based on what it learned about the users, on data gathered from internet or any specific data and preferences analyzed by the home system through time. This characteristic enables a complete paradigm shift in marketing and advertisement media which now can be addressed directly to the house system (which may be given complete or partial purchasing decision authority) instead of to the users.

### BRIEF DESCRIPTIONS OF THE DRAWINGS

The features, objects, and advantages of the present invention will become apparent upon consideration of the following detailed description of the invention when read in conjunction with the drawings in which:

FIG. 1 shows a bock diagram of an implementation example of the herein disclosed automated home system.

### DETAILED DESCRIPTION OF THE INVENTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

Human choices are based on a probabilistic approach, not a deterministic one. Every action humans take is a consequence of a choice based on the probabilistic outcome resulting by the evaluation of multiple options and variables. If the target is to create a home that is actually able to interact with humans and help them perform their everyday tasks, the system needs to mimic the human behavior. The house system needs to operate as a real human assistant capable of managing all operation and logistic aspects of a user's life so as to free user's time and at the same time his or her mind from house related worries/tasks. By leveraging all the collected data, including not only the users biometrics, but also the ones deriving from monitoring the entire house as a whole, the herein disclosed system can help the user live an healthier and longer life.

The present invention describes a fully integrated Artificial-Intelligence based home automation system with multi-users capability aimed to revolutionize the current concept of home and user data mining.

### The Home as a Whole:

### Completeness and Full Integration

All appliances, IOT devices and/or sensors inside and outside the house need to be integrated and connected together so as the generated data can be analyzed as a unified flow of information to describe in real-time what is happening in the house as a whole instead of as a set of independent events and/or user actions. This aspect is fundamental to guarantee the right interaction between the novel house system and the users inside the home. In order to do so, the disclosed home system should be able to get access, at the same time, to as many information as possible.

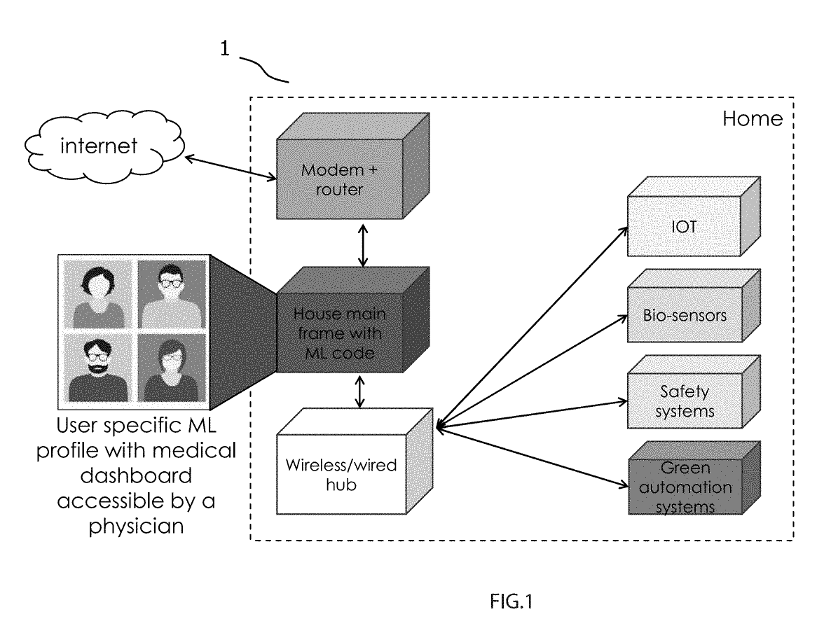

To achieve this target, the disclosed home system may comprise the following elements: a set of electronic devices, each comprising a sensor and/or an actionable feature, a main hub for wireless and/or wired connection to said set of electronic devices; a main-frame where all data related to the house and users are stored and elaborated; a modem/router or gateway to interface the system with the external world, such as internet and other telecommunication systems. An example of implementation of this system is shown in FIG. 1. If desired, the depicted block diagram can be altered so that some of these modules are placed locally and others are placed remotely and/or more than one of these modules can be integrated together in the same unit.

Aside from the most basic and common communication protocols (wired or wireless) such as Bluetooth and Wi-Fi, the new system may be able to leverage the standard power electrical line present in any house to transmit and/or receive video, audio, internet data and in general any kind of data between the main-frame (or hub) and all the peripherals, so as to minimize wireless interferences, maximize reliability and maximize privacy. By using this system, any electrical plug and bulb socket becomes an access point. E.g. a bulb (or lamp) can contain speakers, and/or microphone, and/or video camera, and/or IR camera, and/or light, and/or IR heating, and/or sensors, and/or mapping capability, and/or batteries, etc. . . . , and communicate with the main home system or hub directly through the power line. This result is obtained by transmitting encoded signals through the power line. Different signals can be sent at the same time, e.g. by using a different frequency for each signal or using QAM modulation techniques. Other systems can also be used, such as Ethernet over power line.

To offer a complete solution to the user, the home system herein disclosed should also comprise a multi-technology integrated platform including not only predictive systems based on IOT and sensors, but also robotic automation, homecare, safety, green autonomy, and/or disability oriented features as those discussed more in detail in the following.

The capability of the system to be accessed remotely allows for many other interesting features, such as babysitting (in case where the children age is such that it requires only minimal supervision) and/or pet-sitting for an extended period of time.

### A Full Aware System:

### Awareness and Data Mining

The term “awareness” is defined as “knowledge or perception of a situation or fact”. In order for the home system to be really aware of the situation inside the house and in its surrounding, the home system needs to analyze as many variables as possible.

In order to meet as closely as possible the users' needs, the home system needs to collect and elaborate all available information in an organized fashion. This information can be obtained not only from the interaction of the user with a single device, but also from one of the following categories:
Historical and real-time internally gathered personal data of each user
   Data deriving from the user bio-signal monitoring.
   Data deriving from the user's body scans (visual, ultrasonic, X-ray and so on).
   User interactions with all the devices in the house.
   User behavior recorded by the sensors distributed in the house.
   Data deriving from the position tracking of the user.
   Dietary habits; e.g. derived from the analysis of the house food inventory, e.g. periodically (or action based) scanning the inside of the fridge and pantry.
Historical and real-time externally gathered personal data of each user
   Data deriving from other user accounts, such as Amazon, bank accounts, Facebook, YELP, and so on.
   Data deriving from user phone (e.g. GPS).
   Data deriving from user smart wear, e.g. wallet and/or watch, etc. . . .
   Medical data deriving from external user records and/or institutions.
Historical and real-time internal data
   User interaction with all the devices in the house in connection to the behavior and interactions with the same or different devices by other users.
   Data deriving from interactions between different users.
   Data deriving from the position tracking of the user with respect to the other users.
Historical and real-time external data
   Data deriving from external media sources, such as media and telecommunications systems.
   Data deriving from other smart building system units (including systems in houses, stores, offices and so on).

All these information must be analyzed as whole, so as to capture all possible inter-relations and cross-dependencies between the different aspects of the users' life and between the various users. The capability of the disclosed home system to access to such comprehensive sets of information, never obtainable before, makes the system the most complete collection of user/family information.

Through all collected data, the disclosed system can also leverage third party companies and/or service to indirectly improve users life. For example, the user data obtained from one or multiple-home systems can be used as a whole for the following applications:
Energy load prediction and direct communication with gas and electricity energy grids/providers and/or other houses, e.g. to manage energy requests (for example deciding when turn on or off appliances).
Real time water monitoring and water managements in collaboration with the water company.
Delivery optimization and organization (e.g. organized/joint grocery delivery).
Telemedicine based health care systems so as to allow hospitals to save money.
Life, health, car (and so on) insurance personalization, savings, and managements.
Retirement and pension life expectancy predictions.
Contextual advertisement & Machine-to-machine advertisement.
Traffic prediction.
Education improvement: Schools-home communication, kids improvements/behavior, community organization/comparison, kids education, homework submissions, homework correction, and so on. School oriented education, with suggestions (e.g. documentaries). The disclosed system can function as teacher assistant.
The collected data can be leveraged by scientific institutions and third party companies to create or validate scientific discoveries and studies.
Social activities in general can greatly benefit from the disclosed system.

### A User-Centered System:

### User Specific Structure and Seamless Interaction

In order to meet the uniqueness of each user needs, each person has its own profile, which is created the first time the user logins into the house system. Main user information can be imported from external accounts such as social media (e.g. Google and/or Facebook and/or Linkedin), webpage accounts, bank accounts, insurance accounts, and so on. The user may express his initial preferences through an interactive (voice and/or visual based) questioner which is used as a starting point for the machine-learning algorithm. The required user explicit interaction after this setup procedure is minimized. The personal profile may include also user medical information and/or records and/or a 2D or 3D rendering of the user himself.

After the initial setup, the profile is continuously updated based on the information collected over time of the user behavior, monitoring systems and other internal and external sources (including all external user accounts, e.g. Facebook and/or LinkedIn, and/or webpage accounts, bank accounts, insurance accounts) as previously mentioned. By doing so, the home system is not only capable to predict and satisfy the user specific needs, but also to give suggestions and information—related to its interests and personal situation.

In one embodiment of the present invention, the home system exhibits the capability to interact with different users without requiring them to wear identification tags or other monitoring devices. Every information is collected without placing any burden on the user. The interaction is therefore seamless, and the user required actions are minimized as much as possible.

This approach can be implemented in different ways. One example is to use visual/thermal/IR/biometric/LIDAR recognition systems—including or not rotating sensors and/or camera—to identify and track each user in the house. The system can also track each user phone GPS to know where they are and predict when they will be coming home. Data can be downloaded and/or uploaded from any user account, or from/to the user car and/or his/her phone.

The user-profile and/or the house system data can be transferred if the homeowner moves to a new house. This concept can be extended so that each user account/profile can, for example, be transferred and/or adapted from house to house also when the user is simply renting a new house.

### An Intelligent System:

### Self-Learning and Self-Aware Architecture

In order to analyze in real-time all collected data in an interrelated way and continuously evolve and change alongside with the users and their habits, the home system utilizes a machine-learning algorithm based on multi-neural network structures capable of analyzing thousands or even millions of input data, while at the same time keeping track of their historical behavior. This machine-learning algorithm can be implemented in a neuromorphic integrated circuit, in a graphical process unit based machine or in a more common computer architecture.

Machine learning algorithms have the capability to learn from and make predictions on data. Such algorithms overcome following strictly static program instructions by making data-driven predictions or decisions. Machine learning is employed in a range of computing tasks where designing and programming explicit algorithms with good performance is difficult or infeasible, such as self-driving car systems. Machine learning algorithms can be supervised or unsupervised, and they can be used to learn and establish baseline behavioral profiles for various entities and then used to find meaningful anomalies.

The self learning core program of the system herein disclosed may be composed from multiple modules implementing different AI algorithms optimized for different functions, to mimic the human brain. Furthermore, these modules may have neural network nodes in common so as to comprehensively analyze the whole environment. Each one of these modules can comprise multiple algorithms running in parallel or in series and based on the same data. Multiple approaches instead of a single one, may be implemented based on the specific application: self learning approach, anomaly detection, compression, suggestion algorithm, transfer learning, and many other.

In order to speed up the learning process, the disclosed home system may use a collaborative filtering algorithm which employs user rating and/or choices from other users and houses to characterize features and actions that are implemented in the house (similar to what a machine learning program does for classifying movies and learn user preferences). The home system may also use transfer learning, and/or vocabulary-like database structures, by collecting a general database that can be reused for all users, like a vocabulary of cross-dependences between different users and/or different electronic features in the house. For example user j tells the main frame that he or she likes to turn on the lights before he or she opens the garage in the morning. Then the same proposal is made to user i in another and/or same house. The house can send out selective data to specific entities for example water usage, predict traffic, etc . . . , so as to help service providers. Crowd-sourcing and surveys can also be used to form and/or complete the database. Extra neurons can also be automatically added based on learning speed and data volume. Furthermore, the described program can ask questions and analyze answers, e.g. to increase knowledge or clarify an information.

Each house system herein described can comprise its own profile which can be continuously updated, as it does for one of its users. This profile can be used to form a house “personality”. Alternatively, or in combination to the home profile, a dedicated neural network module may be used to create a home personality which evolves with time.

In general, both the users profiles and the house profile can be formatted in different ways. These profiles can be treated as a set of dedicated information or as a set of dynamic weights, leaving to the learning program the capability to change their values in accordance to the learning experience.

### External Use of Data:

### External Data Access and Related Automation

All the collected information, aside from being used to continuously update each user profile and the internal home profile so as to benefit the user as previously discussed, can be shared in real time with external institutions, e.g. a physician, in a graphical and easy-to-understand format. With this new technology for example, physicians can now collect easily long-term and specialized data and track patient health behaviors over long periods of time. The disclosed house system can be therefore used to help physicians perform better and faster diagnosis, prognosis and therapies. The home system can follow the user therapy progress remotely and interact or adapt the therapy based on the monitored results. This system can be extended to partially or completely eliminate the need for senior homes, which can be now cared for directly in the comfort of their homes.

By monitoring how the user biometrics change over time, it is possible to prevent fatal diseases and provide a timely emergency response in case the data values deviate from the normal range (which can be different for each person and must be therefore derived from long-term observation). Example of the fatal diseases or acute conditions are: heart attacks, household accidents, etc. . . . . Service provider companies can also optimize their service based on the selective data reported to them by the house system.

The disclosed system enables remote testing of patients. Tests that today are performed in dedicated hospital centers, can be now performed directly at home and with much higher frequency. For example, children hearing testing can be simply performed periodically directly at home, guaranteeing the prevention of hear loss. Another example could be the early detection of skin cancer by monitoring often the users skin. In general prevention could be greatly enhanced thus catching on time otherwise fatal diseases and therefore saving lives and decreasing the general cost of health care. This feature together to the ones discussed above, brings telemedicine to an entire new level allowing for a novel fully accessible and easy to use health care system.

By knowing the dietary habits of the users and the food inventory present at any time in the house, the proposed home system can order grocery online and use home-delivery to replenish the house inventory. Using a similar system to catalog and monitor user consumptions, inside the house, of other items, such as water, toilet paper, cleaning products and so on, the house can re-order all the items required for the user to live comfortably without leaving its premises. Ad-hoc cartridges can be also developed and used throughout the house to replenish most commonly used items. E.g. dedicated cartridges comprising cleaning solutions can be used in the toilet to allow self-cleaning of the same without human intervention; food dispensers can be developed to prepare fast meals using cartridges containing food, and so on.

Another interesting feature of the house is that in case of an emergency situation, aside from contacting the public authorities, the system can guide the user and help save his/her life or the life of other persons in the house.

The fact that the house system knows at any moment what a specific user is doing, when he is doing it and where he is doing it, can be used to run contextualized advertisements on smart mirrors, screens or monitors, television and any other appliances/IOT devices based on very precise and real time information, so as to help the user in finding what he or she actually may need at the right time of the day, instead of overloading the user with generic advertising messages (or specific ones but at the wrong time of the day) as it is commonly done on TV. E.g. if the user is in the bathroom and he is brushing his or her teeth, the smart mirror can show an advertising message concerning a new toothpaste which has the characteristics tailored to the specific user.

The disclosed system can automatically remove (some or all) advertisement media transmitted by third parties to the users through television and/or radio and add its own targeted advertisement messages accurately selected by the home system. This can be achieved by providing an on-screen guide of scheduled broadcast programming television and/or radio programs, whose features include preferred program schedules which record every new episode of a series or radio program, and searches which allow the user to find and record shows or radio programs that match their interests by title, actor, director, category, or keyword. Or the system could replace in real time the commercials broadcast through television channel s by interjecting the TV signal and introducing the more dedicated targeted ads or commercial onto the same monitor. This novel method for advertisement could benefit the users who do not have to watch or listen to completely undesired product promotions and the product and advertising companies who would spend their money more wisely and effectively to promote their products.

The central company that provides this machines can act as a link between the third party company and the user. The company managing, programming and updating these house systems could be the link between the product or advertising companies and the final users and therefore may benefit tremendously from the more targeted advertising methods by profiting for passing the advertising media to the house systems. Each house system, also based on the user preferences, would then pass the suited advertising media to the users. This method would revolutionize how online and TV advertising is taking place by possibly reducing the general cost of product promotion per advertising and increasing exponentially the advertising base.

The disclosed home system may make decisions on what to purchase based on what it has learned about the users, on data gathered from internet or any specific data and preferences analyzed by the home system through time. For example, if the user is usually trying to save money (or based on his bank account activity that is the best decision) the house may decide to purchase more often something if it can be found at a discount. The user can also decide what are the parameters (such as money saving, healthy choices and so on) that the house system has to use (in addition to what it learns from the users and external data) when ordering products. These characteristics enable a complete paradigm shift in marketing and advertisement media which can be addressed directly to the house system (which has purchasing decision authority) instead of to the users, which could change drastically the advertising market as we know it today.

Even the current most advanced machine learning program present on the web has the big drawback to continue to re-propose to the user the same thing over and over if the user has demonstrated interest in some kind of product, even after the buyer has purchased the product. The above described system instead, has knowledge of any object in the house and possibly any bank transaction, and therefore knows also when the item has been purchased and can stop running advertisements about the product once this has been purchased.

If products are advertised directly to the home system instead of to its users, than the advertisement can contain much more data than what would be possible for a human to apprehend. Furthermore, the home system can perform further research on the product through internet and/or by asking to other houses systems, which maybe have already bought the products and have a feedback from their users. This will allow the AI home systems to purchase products in a highly informed manner with higher probability to satisfy user needs.

The disclosed system can indeed perform a completely unbiased search on the internet without steering its ranking results due to advertiser bids as it is commonly done today in shopping search features such as Google Shopping where by default, ranking is based on a combination of advertiser bids and relevance, such as current search terms and activity.

Once the search results are proposed to the user, the search algorithm can use the direct user feedback to improve on its performance. For example, once the user requests the home system to purchase new items, the home system can perform the internet search and propose to the user the three most relevant found results. The user can then request the system to purchase one of them or re\iterate the search with further parameters or ask for more results. The fact that the house system knows which item the user decides to buy (or request to the home system to directly purchase) gives the home system a direct feedback on the search algorithm, which can then be used to improve the algorithm itself.

To make purchases, the disclosed home system may utilize one or more users accounts or have its own financial account (or account with a financial institution). Similarly, the disclosed house system can have its own accounts for any online activity (e.g. Amazon, Google or Pandora account).

The network of home systems, will therefore be able to generate a great amount of marketing data which can be used by the different companies to improve their products, and in general improve competition among companies. Furthermore, a product review process can be greatly simplified by letting the house system know if the user liked the product (the house system can also ask to the user questions about it). The user, on the other hand, will minimize his cost of living and maximize his experience. Privacy could be greatly increased as well by doing all the shopping in an anonymous manner, without disclosing the identity of the users, since the house system may use a pseudonym or any fictitious name to hide the users real identity. Houses can choose to divulgate information or not on the product feedback based on user settings.

The disclosed home system introduces an extra shielding layer between the advertising company and the user himself to help the user increase his purchase experience and efficiency. This layer perfectly counterbalances the extra “AI driven” layer introduced by the advertising companies between them and the users so as to determine more effectively what are the user's interest and to increase target marketing.

Furthermore insurance companies can adjust their prices based on how people live their lives, encouraging a healthier life style and reducing premium costs for the most virtuous users.

The disclosed system can also leverage all the collected information of the user to guarantee a superior security to the user himself. For example, the house system is able to detect credit card fraud much better than a bank since has much more real-time and historical information on the user.

Another interesting feature that the disclosed system can integrate is the capability to revolutionize home gaming and online gaming, allowing a complete new way to interact between players of different homes integrating the disclosed AI system.

The network of home systems, can also be used to create a high priority communication channel between houses in case of emergency, such as earthquake, fire, burglary and so on. For example, an house can alert the neighbors that a fire has started into the house and unlock all the doors so as to allow the neighbors to enter the premises and help to extinguish the fire.

It is therefore an objective of the present invention to create something deeply functional and future-ready that, by mimicking all the most basic characteristics of human beings and beyond, is able to provide a user-centered system to help the user: perform his or her daily tasks, reduce stress level, highly optimize time-managing, be more aware of his or her health, prevent medical conditions, live a better and healthier life (better diet, continuous health monitoring); manage administrative tasks (as pay bill in time, manage activities, appointments and lists); keeping him or her safe; know what to do in case of emergency; create effective emergency response and at the same time being more energy/resources conscious, purchase needed items online while improving their search and reducing browsing and transaction time consuming tasks.

Furthermore, the house system and the features thereof can be customized based on the targeted user, based on age, or education or personal preferences. For instance a smart home for seniors may have some needs that other occupants may not care about, and therefore the features offered in the house can be tailored to reflect that.

Although the present invention has been described above with particularity, this was merely to teach one of ordinary skill in the art how to make and use the invention. Many additional modifications will fall within the scope of the invention. Thus, the scope of the invention is defined by the claims which immediately follow.

As is clear to those skilled in the art, this basic system can be implemented in many specific ways, and the above descriptions are not meant to designate a specific implementation.

What is claimed is:

1. A method to automate a building system, the method comprising:
receiving a first set of data from multiple device units present in a building;
associating at least a subset of said first set of data to a specific user by means of an identification system;
classifying and storing at least said subset of said first set of data based on said association;
processing at least said subset of said first set of data by means of an artificial intelligence program;
using a result of said processing to update at least a user habit profile,
using said result to create a control signal;
sending said control signal to at least one of said multiple device units to selectively control one or more features thereof, and
wherein said artificial intelligence program performs an analysis.

2. The method of claim 1, wherein said building system comprises a dedicated building profile.

3. The method of claim 1, wherein said building system comprises a dedicated building profile, and wherein said dedicated building profile comprises a set of parameters that are learned in accordance to a machine-learning algorithm.

4. The method of claim 1, wherein said building system comprises a dedicated building profile, and wherein said dedicated building profile can be transferred to a second building system.

5. The method of claim 1 wherein said user habit profile can be transferred to a second building system.

6. The method of claim 1, wherein a power line of said building system is used to transmit and/or receive signals between at least one of said multiple device units and a unit transmitting said control signal.

7. The method of claim 1,
wherein said building system receives a second set of data from at least one source belonging to a group comprising: an external network, one or more user accounts generated externally from said building system, one or more electronic devices physically located externally to said building system, and
wherein said analysis comprises also said second set of data.

8. The method of claim 1 wherein said building system can be accessed and/or controlled remotely by an individual or an institution.

9. The method of claim 1, wherein any data generated in said building system can be used to interact with another user or said user in a second building.

10. Multiple building units each one using a system according to the method of claim 1, wherein said systems in said multiple building units can exchange information between them.

11. The method of claim 1, wherein said analysis by means of said artificial intelligence program is used to identify at least one of the following relations: a temporal and/or spatial pattern in the stored data, a temporal and/or a spatial pattern in the interactions of one or more users and one or more devices, a temporal and/or spatial cross-dependence between data associated to different users, a temporal and/or spatial cross-dependence between data associated to the interaction of said specific user with other users.

12. The method of claim 1, wherein said first set of data is used to run contextualized market advertising, targeted to specific users at specific times of the day and/or in specific areas of the building.

13. The method of claim 1, wherein a machine-to-machine advertisement system is used to send advertisement data to said building system.

14. The method of claim 1, wherein said building system receives advertisements from an advertising entity to promote products or services directly to said building system.

15. The method of claim 1, wherein said building system is authorized and capable of making purchases, directly from a company, using funds in accounts of said specific user or in a dedicated building system financial account.

16. An automated building system comprising:
a building,
multiple device units,
a mainframe unit,
one or more user profile, and
a dedicated building profile;
wherein said building system receives data from at least one source belonging to a group comprising: one or more of said multiple device units, an external network, one or more user accounts generated externally from said building system, one or more electronic devices physically located externally to said building;
wherein said mainframe unit associates at least a subset of said data to a specific user by means of an identification system or to said building;
wherein said mainframe unit classifies and stores at least said subset of said data based on said association;
wherein said mainframe unit processes at least said subset of said data by means of an artificial intelligence program.

17. An autonomous building system comprising:
a building,
at least one device unit,
a mainframe unit,
at least one user profile, and
a dedicated building profile;
wherein said autonomous building system receives data from at least one source belonging to a group comprising: at least one of said device unit, an external network, one or more user accounts generated externally from said autonomous building system, one or more electronic devices physically located externally to said building;
wherein said mainframe unit processes at least said subset of said data by means of an artificial intelligence learning program, and
wherein said autonomous building system is capable of making purchases autonomously using funds out of a dedicated financial account.

18. A financial account associated to the autonomous building system of claim 17,
wherein said autonomous building system is provided with a means of authorizing charges to said financial account in order to make online purchases.

19. An advertising method comprising:
the autonomous building system of claim 17,
wherein said autonomous building system is directly targeted by advertising companies to promote products and/or services.

20. The autonomous building system of claim 17,
wherein said autonomous building system makes intelligent decisions regarding said purchases based on said data and/or based on any other type of collected information.
